(19) United States
(12) Patent Application Publication
(10) Pub. No.: US 2007/0068748 A1
(43) Pub. Date: Mar. 29, 2007

(54) Combined service and auxilliary brake apparatus

(76) Inventor: Stefan Chittka, Ludwigsburg (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/525,045

(22) Filed: Sep. 22, 2006

(30) Foreign Application Priority Data
Sep. 29, 2005 (DE) 20 2005 015 404.0
Nov. 18, 2005 (DE) 10 2005 055 084.3

(51) Int. Cl. F16D 55/08

(52) U.S. Cl. 188/72.7

(57) ABSTRACT

A combined service and parking brake apparatus having a brake unit equipped with a brake disc and at least one brake pad in which a fluid pressure actuatable brake piston is able to place the brake pad against the brake disc and having a parking brake unit, which includes an electric drive unit, a transmission, and a spindle unit equipped with a nut and spindle in order to mechanically lock the brake unit in a parking brake position, and in which the electric drive unit, the transmission, and the spindle unit are situated in series on a common axis.

### CROSS REFERENCE TO UNRELATED APPLICATIONS

This application is based on German Patent Application Nos. 20 2005 015 404.0 filed on Sep. 29, 2005 and 10 2005 055 084.3 filed on Nov. 18, 2005, upon which priority is claimed.

### BACKGROUND OF THE INVENTION

1. Field of the Invention

The invention relates to a combined service and parking brake apparatus for vehicles.

2. Description of the Prior Art

A wide variety of combined service and parking brake apparatus designs are known from the prior art. A brake apparatus of this kind includes, for example, a hydraulic service brake and a mechanical parking brake (emergency brake). Recently, parking brakes are no longer mechanically actuated solely by means of a control cable, but are instead actuated by means of an electric motor mounted directly on the wheel brake. The electric motor drives a spindle unit, which mechanically sets and locks the brake unit in a parking brake position.

When placing electric motors of this kind directly next to the wheel brake, however, space problems arise because there is very little space around the wheel brake. To this end, DE 197 32 168 C1 has proposed situating an electric motor for driving a parking brake apparatus on the wheel brake, to the side of the vehicle brake housing. In this instance, a driven shaft of the electric motor extends parallel to an axle of the spindle, spaced laterally apart from it. The driven shaft of the electric motor and the spindle are connected to each other by means of a step-down transmission. This arrangement, however, has the disadvantage that space must necessarily be available to the side of the wheel brake in order for the electric motor to be placed there.

### OBJECT AND SUMMARY OF THE INVENTION

The combined service and parking brake apparatus according to the present invention has the advantage over the prior art of a particularly simple, compact design. According to the present invention, no space is required to the side of the vehicle brake housing. This is achieved according to the present invention by virtue of the fact that an electric drive unit, a transmission, and a spindle unit are situated in series on a common axis. The electric drive unit and the transmission are selected to be small and very compact in the axial direction. In addition, the placement on a common axis makes it possible for the motor and/or the transmission to be embodied as rotationally symmetrical. Moreover, the present invention permits a housing structure of the vehicle brake housing and a housing for the electric drive unit, transmission, and spindle unit to be very simply embodied, for example in a cylindrical form. This makes the housing simple to produce and easy to seal. This results in a reduced susceptibility to corrosion and a reduced tendency to become contaminated.

A particularly compact design can be achieved if the common axis for the electric motor, transmission, and spindle unit is simultaneously also a center axis of a brake piston of the service brake. In a particularly preferred embodiment, the brake piston is essentially cup-shaped and the spindle unit is completely accommodated inside the cup-shaped piston. This makes it possible to achieve a design that is particularly compact in the axial direction.

According to another preferred embodiment, the electric drive unit and the transmission are embodied as a common structural unit. This permits the motor/transmission unit to be preassembled, tested, and calibrated if need be, before being mounted onto the wheel brake. It also permits a quicker, less expensive replacement of the motor/transmission unit.

In a particularly preferred embodiment, a form-locked clutch is provided to produce the connection between the spindle unit and the transmission or motor/transmission unit. The use of the form-locked clutch makes it possible to compensate for tolerances between the motor/transmission unit and the brake housing or the brake caliper with the spindle unit.

Preferably, the electric drive unit and the transmission are accommodated in a shared, essentially cylindrical housing. This makes it possible to achieve a particularly simple, compact design. The housing is simple to produce and easy to seal and is also less susceptible to corrosion.

According to an alternative preferred embodiment of the present invention, the transmission is described as a Wolfrom transmission. The Wolfrom transmission includes a sun gear, a stationary first outer ring gear, a rotating, driven second outer ring gear, and first and second planet gears, which are respectively situated on a common planet gear shaft. The electric motor is connected to the sun gear and the spindle unit is connected to the driven outer ring gear. A Wolfrom transmission of this kind is very compact in the axial direction and its length in the axial direction essentially corresponds to the width of the two outer ring gears.

In a particularly preferred embodiment, the transmission is a sun-and-planet gear since this takes up very little space in the axial direction. The electric motor is preferably connected to a sun gear of the sun-and-planet gear and the spindle unit is connected to an outer ring gear or a planet gear.

According to another embodiment of the present invention, the transmission is embodied in the form of a harmonic drive transmission, a cycloid transmission, or a swash plate transmission.

The electric motor is preferably a d.c. motor, in particular a brushless d.c. motor.

According to another preferred embodiment, an axial length of the electric motor is less than or equal to half the outer diameter of the electric motor. This assures that the electric motor has a minimal axial length with a sufficient power density.

According to another preferred embodiment, an axial length of the transmission is less than or equal to half the outer diameter of the transmission. This similarly assures that the transmission is particularly compact in the axial direction.

Preferably, the plug connector is situated on the side of the motor/transmission/spindle unit in order to reduce the axial length and save axial space. The axis of the plug can be situated at an arbitrary angular position in relation to the axis X-X of the motor/transmission/spindle unit. This permits a high degree of flexibility in adapting the combined service/parking brake apparatus to a variety of vehicles. Preferably, a plug connector of the electric motor is situated parallel to the common axis of the electric motor, transmission, and spindle unit. This makes it possible to further reduce the axial length of the electric motor since the plug connector is thus situated on the side of the electric motor. Since the plug connector has only a small width, only a small amount of lateral space is required. It should be noted that a different lateral orientation of the plug can also be selected, e.g. one extending radially in relation to the common axis of the motor/transmission unit. It is also possible to vary the position of the plug in any angular position around the axis of the motor (360° range of freedom).

According to another preferred embodiment of the present invention, the shared housing of the electric drive unit and transmission is closed by a cover at the end oriented toward the electric drive unit. In this case, parts of the electric drive unit are situated on and/or in the cover. The cover can, for example, contain connecting lines to a plug connector, holding devices for a stator of the electric drive unit, a bearing for a rotor of the electric drive unit, or a brush holder of the electric drive unit. According to another preferred embodiment, the shared housing is embodied in the form of a pole cup for the electric drive unit so that the electric drive unit can be embodied in a compact fashion. When an essentially cylindrical housing is used, it is also possible to produce a simple seal between the housing and the cover by means of a ring seal.

According to another preferred embodiment of the present invention, at least one device is provided for determining the position of the parking brake in order to ascertain whether or not the parking brake position is mechanically locked in place. The position-determining device can, for example, be a device for detecting a motor current and/or a motor voltage of the electric motor. Alternatively, a sensor can be provided to detect the speed or angular position of the driven shaft of the electric motor or spindle of the spindle unit. The sensor can, for example, be a Hall sensor. It is also possible to provide an optical sensor and/or a force sensor to determine a locking force.

### BRIEF DESCRIPTION OF THE DRAWINGS

The invention will be better understood and further objects and advantages thereof will become more apparent from the ensuing detailed description of preferred embodiments, taken in conjunction with the drawings, in which:

FIG. 1 is a schematic sectional view of a combined service/parking brake apparatus according to one exemplary embodiment of the present invention, and

FIG. 2 is a sectional view along the line A-A in FIG. 1.

### DESCRIPTION OF THE PREFERRED EMBODIMENTS

Functioning as the service brake of a vehicle, the combined service and parking brake apparatus of the invention is operated by means of hydraulics. Pressurized hydraulic fluid is supplied to a fluid chamber 10, which is connected to a hollow inner region of an essentially cup-shaped working piston 7. In the event of a pressure increase in the fluid chamber 10, the operating piston 7 is moved in the direction of the arrow A in order to place brake pads against a brake disc in an intrinsically known fashion.

The service and parking brake 1 according to the present invention also includes a parking brake part, which essentially includes an electric motor 2, a transmission 3, and a spindle unit 4. The parking brake according to the present invention is a so-called MOC type (motor on caliper), in which a driver request to actuate the parking brake is transmitted by means of an electrical signal to a control unit, which operates the electric motor in order to mechanically engage the parking brake. The brake caliper of the combined service/parking brake is tightened and mechanically locked in place. In this case, the electric motor 2 is embodied as a d.c. motor.

The transmission 3 is a Wolfrom transmission with a sun gear 30, a stationary outer ring gear 31, a rotating outer ring gear 32 on the driven side, planet gears 33 of a first planet gear set, and planet gears 34 of a second planet gear set. The planet gears 33 of the first planet gear set engage with the sun gear 30 and the stationary outer ring gear 31. The planet gears 33 and 34 are situated on common planet gear supports. The planet gears 34 of the second planet gear set engage with the outer ring gear 32 on the driven side.

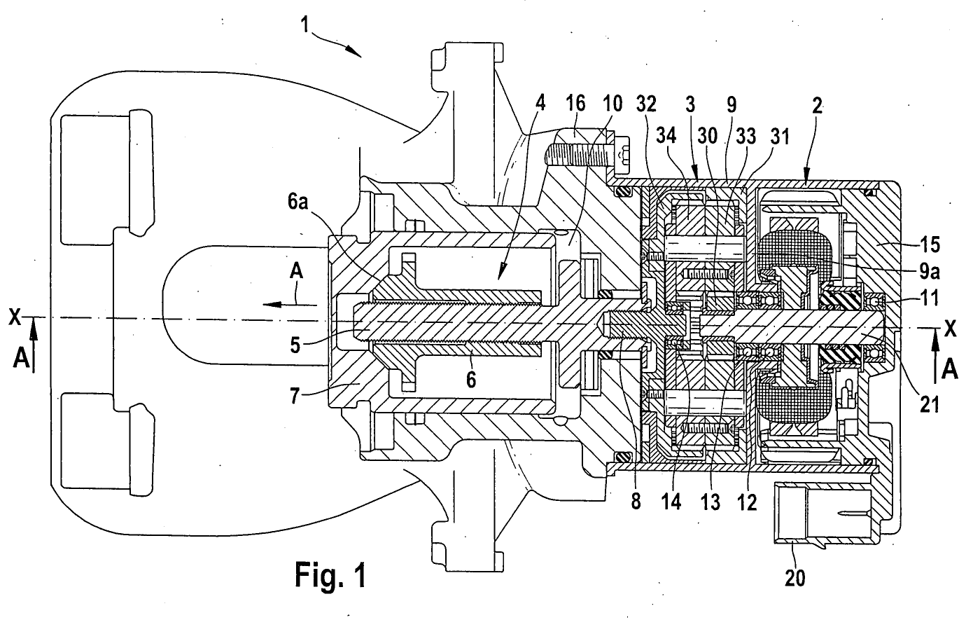

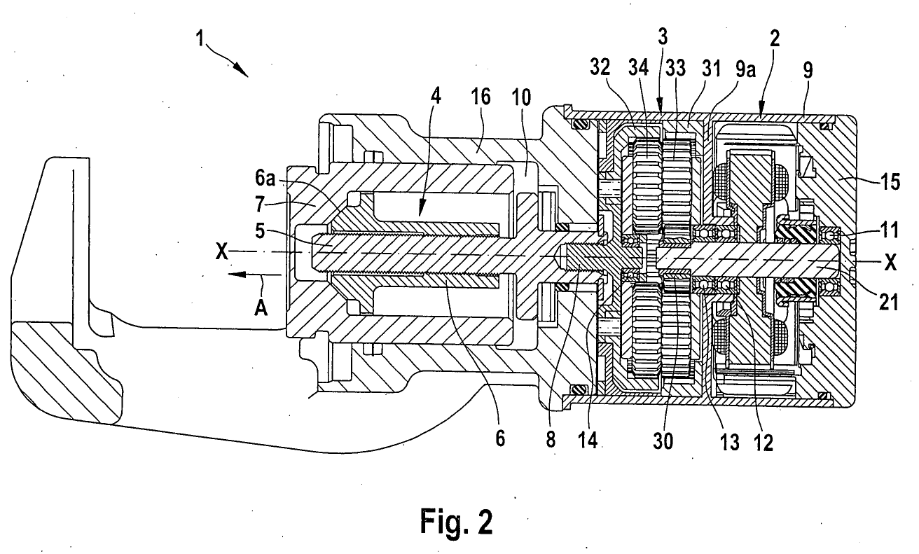

The outer ring gear 32 on the driven side is connected via a form-locked clutch 8 to a spindle unit 4. The spindle unit 4 includes an externally threaded spindle 5 and a nut 6 that is situated on the spindle 5. When the spindle 5 rotates, the nut 6 moves in translatory fashion in the axial direction X-X of the service/parking brake. When the parking brake is in the locked state, which is shown in FIGS. 1 and 2, an end region 6a of the nut 6 contacts the inner piston bottom of the brake piston 7 so that the brake piston 7 is mechanically locked in position. In this instance, a self-locking thread is provided between the spindle 5 and the nut 6 in order to prevent an automatic locking of the spindle unit 4.

As is also apparent from FIGS. 1 and 2, the electric motor 2 and the transmission 3 are accommodated in an essentially cylindrical shared housing 9 which at an approximately central position in the axial direction, has an inwardly oriented region 9a. A cover 15 closes the shared housing 9 at its end oriented toward the motor.

The electric motor 2 is embodied in the form of a d.c. motor and includes a rotor and a stator; a driven shaft of the electric motor is labeled with the reference numeral 21. The driven shaft 21 is connected to the sun gear 30 of the Wolfrom transmission and drives it. As is apparent from the drawings, the driven shaft 21 is supported in a first bearing 11, a second bearing 12, and a third bearing 13. The second bearing 12 also serves to simultaneously support the shared housing 9 by means of the inwardly oriented region 9a. The outer ring gear 32 on the driven side of the transmission 3 is also supported on a fourth bearing 14. As is apparent from the drawings, the outer ring gear 32 on the driven side is integrally joined to the form-locked clutch 8, thus making it possible to reduce the number of parts.

In addition, parts of the electric motor 2 are attached to and/or integrated into the cover 15. In addition, the first bearing 11 is provided in the cover 15. This permits the electric motor 2 to be premounted onto the cover 15 and simply inserted into the cylindrical housing 9 as a single structural unit. The housing 9 is also embodied in the form of a pole cup for the electric motor 2, with corresponding electromagnetic properties. The housing 9 thus performs several functions simultaneously.

Since the transmission 3 can also be preinstalled in the shared housing 9 from the other side, this produces and easy-to-handle structural unit. By means of the shared housing 9, this structural unit can be attached to the housing 16 of the wheel brake. The preassembled motor/transmission unit can also include the clutch 8.

As shown in FIG. 1, a plug connector 20 of the electric motor 2 is situated on the side and parallel to the central axis X-X of the service/parking brake 1. The plug connector 20 here can be manufactured so that it is integrally joined to the cover 15. The plug connector 20 is therefore very small in width.

As is apparent from the drawings, the service/parking brake according to the present invention is embodied in such a way that the electric motor 2, the transmission 3, and the spindle unit 4 are situated on a common axis X-X. The electric motor 2 and the transmission 3 are thus embodied as particularly short in the axial direction. In this case, the arrangement is such that the electric motor 2, the transmission 3, and the spindle unit 4 are situated in series on the common axis X-X. The common axis X-X in this case is simultaneously also the central axis of the brake piston 7. Since the spindle unit 4 is completely accommodated inside the brake piston 7, it is possible to further reduce the amount of axial space required. The arrangement according to the present invention also makes it possible to achieve an embodiment that is rotationally symmetrical to the common axis X-X, thus requiring less space in the radial direction of the service/parking brake. As is readily apparent from the drawings, the service/parking brake 1 according to the present invention is very compact and simple in design. In particular, the use of a shared cylindrical housing 9 permits a trouble-free preassembly and attachment of the motor/transmission unit to known wheel brakes of vehicles.

The present invention's series arrangement of the motor, transmission, and spindle unit also has the advantage of permitting a modular assembly concept to be used in which the electric motor, together with the cover 15, can be interchangeably replaced as needed in order to be replaced, for example, by a more powerful electric motor if the service/parking brake is being used in a commercial vehicle, for example, instead of in a passenger vehicle. Naturally, the entire motor/transmission unit can be completely replaced with a different one if necessary. This also makes it possible to carry out simple repairs or to replace components. Moreover, the compact motor/transmission unit also allows the parking brake to be simply adapted to the requirements of various vehicle manufacturers.

The foregoing relates to preferred exemplary embodiments of the invention, it being understood that other variants and embodiments thereof are possible within the spirit and scope of the invention, the latter being defined by the appended claims.

I claim:

1. A combined service and parking brake apparatus comprising a brake unit equipped with at least one brake disc and at least one brake pad in which a fluid pressure actuatable brake piston is able to place the brake pad against the brake disc, and a parking brake unit, which includes an electric drive unit, a transmission, and a spindle unit equipped with a nut and spindle in order to mechanically lock the brake unit in a parking brake position, the electric drive unit, the transmission, and the spindle unit being situated in series on a common axis.

2. The brake apparatus according to claim 1, wherein the common axis is also a central axis of the brake piston.

3. The brake apparatus according to claim 1, wherein the electric drive unit and the transmission are embodied in the form of a structural unit that can be preassembled.

4. The brake apparatus according to claim 2, wherein the electric drive unit and the transmission are embodied in the form of a structural unit that can be preassembled.

5. The brake apparatus according to claim 1, wherein the transmission is connected to the spindle unit by means of a form-locked clutch.

6. The brake apparatus according to claim 4, wherein the transmission is connected to the spindle unit by means of a form-locked clutch.

7. The brake apparatus according to claim 1, wherein the electric drive unit and the transmission are accommodated in a shared, essentially cylindrical housing.

8. The brake apparatus according to claim 3, wherein the electric drive unit and the transmission are accommodated in a shared, essentially cylindrical housing.

9. The brake apparatus according to claim 1, wherein the transmission is a Wolfrom transmission having a sun gear, a stationary outer ring gear, a rotating outer ring gear on the driven side, planet gears of a first planet gear set, and planet gears of a second planet gear set, the electric drive unit being connected to the sun gear and the spindle unit being connected to the outer ring gear on the driven side.

10. The brake apparatus according to claim 7, wherein the transmission is a Wolfrom transmission having a sun gear, a stationary outer ring gear, a rotating outer ring gear on the driven side, planet gears of a first planet gear set, and planet gears of a second planet gear set, the electric drive unit being connected to the sun gear and the spindle unit being connected to the outer ring gear on the driven side.

11. The brake apparatus according to claim 1, wherein the transmission is embodied in the form of a sun-and-planet gear, a harmonic drive transmission, a cycloid transmission, or a swash plate transmission.

12. The brake apparatus according to claim 7, wherein the transmission is embodied in the form of a sun-and-planet gear, a harmonic drive transmission, a cycloid transmission, or a swash plate transmission.

13. The brake apparatus according to claim 1, wherein the electric drive unit is a d.c. motor, in particular a brushless d.c. motor.

14. The brake apparatus according to claim 1, wherein an axial length of the electric drive unit is less than or equal to half the outer diameter of the electric drive unit.

15. The brake apparatus according to claim 7, wherein an axial length of the electric drive unit is less than or equal to half the outer diameter of the electric drive unit.

16. The brake apparatus according to claim 1, wherein an axial length of the transmission is less than or equal to half the outer diameter of the transmission.

17. The brake apparatus according to claim 9, wherein an axial length of the transmission is less than or equal to half the outer diameter of the transmission.

18. The brake apparatus according to claim 1, further comprising a plug connector of the electric drive unit situated on the side of the motor/transmission/spindle apparatus parallel to the common axis.

19. The brake apparatus according to claim 7, wherein the shared housing is closed off from the electric drive unit and the transmission on the end oriented toward the drive unit by means of a cover, and wherein parts of the electric drive unit are situated on and/or in the cover.

20. The brake apparatus according to claim 9, wherein the shared housing is closed off from the electric drive unit and the transmission on the end oriented toward the drive unit by means of a cover, and wherein parts of the electric drive unit are situated on and/or in the cover.
